(19) United States
(12) Patent Application Publication
(10) Pub. No.: US 2003/0064903 A1
(43) Pub. Date: Apr. 3, 2003

(54) Low foam producing cleaning-in-place composition

(75) Inventors: Michael Francis Coughlin, Cincinnati, OH (US); Charles Allen Crawford, Lebanon, OH (US)

Correspondence Address: UNILEVER, PATENT DEPARTMENT, 45 RIVER ROAD, EDGEWATER, NJ, 07020, US

(73) Assignee: Diversey Lever

(21) Appl. No.: 09/950,944

(22) Filed: Sep. 13, 2001

(51) Int. Cl. C23G 1/00; C03C 23/00; C23G 1/02; B08B 9/00; B08B 3/00; B08B 3/14; B08B 7/00; C11D 17/00

(52) U.S. Cl. 510/218; 134/22.1; 134/2; 134/3; 134/22.19; 134/36; 134/42; 510/421

(57) ABSTRACT

A composition for a cleaning-in-place system is described. The composition has a defoaming agent and a cleaning agent, and the composition is low foaming. The composition displays excellent cleaning and disinfecting properties on processing equipment such as the equipment found in breweries, dairy plants and carbonated beverage plants, even in the absence of carbon dioxide purging.

### FIELD OF THE INVENTION

This invention is directed to a composition employable in a cleaning-in-place (CIP) system. More particularly, the invention is directed to a CIP composition that does not generate excessive foam and does not require carbon dioxide purging. Also, described herein, is a method for using such a CIP composition.

### BACKGROUND OF THE INVENTION

It is extremely important to clean food processing facilities like breweries, dairy plants and carbonated beverage plants. Typically, such food processing facilities are cleaned by subjecting the internal or external portions of the machines that make up the facilities to a solution that reacts with the various soils present within the machines.

A conventional CIP system, for example, has several storage containers. Each storage container, independently, houses a solution (e.g., pre-rinse solution, cleaning solution, post-rinse solution) that is fed (non-simultaneously) into the facility targeted for cleaning or decontamination. Often, the solutions are pumped into the gas and liquid passages of the machines in the facilities being cleaned and then circulated through the system until they are finally discharged to waste.

Typical CIP systems are known to employ chlorine. However, chlorine is not environmentally friendly and can form by-products with many organic substances found in the facilities being cleaned. These by-products are not desired and can be carcinogenic materials. Also, chlorine may result in carcinogenic by-products in, for example, the waste sites it is finally discharged to. Other CIP systems are known to use active agents like hydrogen peroxide and peracetic acid. Such systems, however, require high levels of the active agents making their uses non-feasible, for example, from an economic standpoint. Furthermore, agents like peracetic acid tend to have a very pungent aroma. CIP systems that use actives which foam are also known, and they often result in poor cleaning and disinfecting properties as well as cleaning equipment malfunctioning. In addition to the above, many conventional CIP processes often have cumbersome process steps which typically require carbon dioxide purging.

It is of increasing interest to prepare a CIP composition that is environmentally friendly and economical to use. This invention, therefore, is directed to a CIP composition that does not result in the generation of environmentally unfriendly by-products, does not result in excessive foaming and does not require carbon dioxide purging. This invention is also directed to a method for using the CIP composition in a food processing facility.

### BACKGROUND REFERENCES

Efforts have been disclosed for cleaning processing equipment. In U.S. Pat. No. 5,888,311, a process for cleaning equipment in the absence of a pre-rinse step is described.

Other efforts have been disclosed for cleaning equipment. In U.S. Pat. No. 5,533,552, a CIP process comprising the step of circulating a cleaning liquid throughout equipment targeted for cleaning is described.

Still other efforts have been described for cleaning equipment. In U.S. Pat. Nos. 4,714,980 and 4,776,974, sanitizing compositions not having defoaming agents are disclosed.

### SUMMARY OF THE INVENTION

In a first aspect, the present invention is directed to a CIP composition comprising:

(a) a defoaming agent; and

(b) a cleaning agent

wherein the CIP composition comprises a total foam height of less than about 15 cm at about 5° C.

In a second aspect, the invention is directed to a method for using the CIP composition of the first aspect of this invention.

As used herein, total foam height is defined as follows:

Fₜ=F_{f}−F_{I}

where Fₜ=total foam height produced by the CIP composition; F_{f}=final foam height of the CIP composition; and F_{I}=foam height of pure deionized water. In a preferred embodiment, the total foam height of the CIP composition of this invention is less than about 10 cm, and preferably, less than about 6.0 cm at about 5° C., wherein the calculation of Fₜ is described in Example 2.

### DETAILED DESCRIPTION OF THE PREFERRED EMBODIMENTS

There is no limitation with respect to the defoaming agent that may be used in this invention other than that the defoaming agent is one which may be used in a CIP composition. Such a defoaming agent typically includes compounds produced by the condensation of alkylene oxide groups (hydrophilic) with an organic hydrophobic compound which may be aliphatic or alkyl aromatic in nature. These defoaming agents preferably include polyethylene oxide condensates of alkyl phenols, e.g., the condensation products of alkyl phenols having an alkyl group containing from about 5 to about 13 carbon atoms in a straight chain or branch chain configuration, with ethylene oxide, the ethylene oxide being present in amounts equal to from about 10 to about 70 moles of ethylene oxide per mole of alkyl phenol. The alkyl substituent in such compounds may be derived from polymerized propylene, diisobutylene, octane or nonane. Compounds derived from the condensation of ethylene oxide with the product resulting from the reaction of propylene oxide and ethylene diamine may also be used. Even further, the condensation product of aliphatic alcohols having from about 8 to about 20 carbon atoms in either a straight chain or a branched chain configuration, with ethylene oxide, may also be used. Such a condensation product includes a fatty alcohol ethylene oxide condensate having from about 2 to about 50 moles of ethylene oxide per mole of fatty alcohol, the fatty alcohol fraction having from about 8 to about 20 carbon atoms.

It is also within the scope of the present invention to use defoaming agents that may generally be classified as long chain tertiary amine oxides, long chain tertiary phosphene oxides, long chain dialkyl sulfoxides, polyalkylene oxide modified dimethyl polysiloxanes, dimethicone copolyols and the like.

The preferred defoaming agents which may be used in this invention include, for example, alcohol alkoxylates sold under the name Dehypon, Synperonic, Dowfax, Macol DF, Plurafac LF, Poly-Tergent; and alcohol ethoxylates sold under the name Lutensol; and amine oxides sold under the name Mazox; and amine-based block copolymers sold under the name Tetronic; and decyl alcohol ethoxylates, sold under the name Iconol; and ethoxylated sorbitan fatty acid esters, sold under the name of T-Maz; and ethylene/propylene oxide block copolymers sold under the name Pluronic; and glycerol esters sold under the name Mazol; and lauryl alcohol ethoxylates sold under the name of Macol and nationally formulary block copolymers sold under the name of Pluronic; and nonylphenol ethoxylates sold under the name of Iconol; and octophenol ethoxylates sold under the name of Iconol; and polyethylene glycol esters sold under the name of Mapeg; and sorbitan fatty acid esters sold under the name of S-Maz. Dehypon is made commercially by Henkel Company, Synperonic is made commercially available by Uniqema, Dowfax is made commerically available by Dow Chemical and the other preferred defoaming agents which may be used in this invention are made commercially available by BASF. The most preferred defoaming agents are sold under the name of Plurafac LF 403 and Plurafac LF 4030 and also made commercially available by BASF, and Synperonic as made commercially available by Uniqema.

There is no limitation with respect to the amount of defoaming agent used in the CIP composition of the present invention as long as the amount used does not interfere with the intended use of the composition. Typically the CIP composition comprises from about 0.2 to about 30%, and preferably, from about 0.3 to about 15%, and most preferably, from about 0.4 to about 3.0% by weight of defoaming agent, including all ranges subsumed therein.

The cleaning agent that may be used in this invention includes those having the formula:

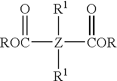

wherein Z is a C₂₋₈ saturated or unsaturated (substituted or unsubstitued) hydrocarbon, each R is independently a C₁₋₄ alkyl or H and each R¹ is independently a C₃ to C₁₈ alkyl group, a C₃ to C₁₈ hydrocarbon having at least one Sp² bond or Sp bond, —OR, or H with the proviso that at least one R¹ (of the total number of R¹) is not an —OR or an H.

The preferred cleaning agent used in this invention is one having each R as hydrogen, Z as a saturated and mono-substituted C₂ hydrocarbon with one R¹ being an n-octenyl group. Such a preferred cleaning agent is known as octenyisuccinic acid and made available from suppliers like Milliken Company.

There is no limitation with respect to the amount of cleaning agent which may be used in this invention as long as a CIP composition is generated, and preferably, a CIP composition that shows substantially no phase separation or precipitation after 90 days at 0° C., 90 days at 50° C., or both. Typically, from about 0.2 to about 60.0%, and preferably, from abut 0.3 to about 40.0%, and most preferably, from about 0.4% to about 15% by weight cleaning agent is used, based on total weight of the CIP composition, including all ranges subsumed therein.

Other additives which may be used in the CIP composition of this invention include acids, hydrotropes and biocides.

The acids which may be used typically include organic acids, mineral acids and mixtures thereof. The mineral acids are often selected from the group consisting of hydrochloric acid, sufuric acid, phosphoric acid and nitric acid. The organic acids include formic acid, phosphonic acid and the like. The amount of acid employed in the CIP composition of the present invention is typically from about 5.0 to about 80.0%, and preferably, from about 10.0 to about 70.0%, and most preferably from about 15.0 to about 50.0% by weight acid! based on total weight of CIP composition, including all ranges subsumed therein.

Regarding the hydrotropes that may be used in this present invention, such hydrotropes include those which are commercially available and may be used in a low foaming cleaning composition. An illustrative list of the hydrotropes which may be used in this invention include surfactants selected from lauryl sulfate, sodium xylene sulfonate, toluene sulfonic acid (and salts thereof), sulfosuccinate salts, sodium cumene sulfonate, phosphate esters, akylpolyglucosides, fatty acids and their salts, and the imidazolines.

The most preferred hydrotropes used in this invention are Triton H-66 and toluene sulfonic acid, the former is generally classified as a potassium salt of a phosphate ester, and made commercially available by Henkel Corporation and the latter is made commercially available from, for example, Rutgers-Organics Corporation. The amount of hydrotrope employed in the CIP composition of the present invention is limited only to the extent that a stable CIP composition may be made. Often, however, from about 0.1 to about 40%, and preferably, from about 0.5 to about 33%, and most preferably, from about 1.0 to about 20.0% by weight of hydrotrope is employed, based on total weight of the CIP composition, including all ranges subsumed therein.

In an especially preferred embodiment, the CIP composition of this invention comprises a mixture of hydrotropes wherein a first hydrotrope (H¹) is sulfonic acid derived and a second hydrotrope (H²) is phosphate ester derived such that the weight percent of H¹-H²/weight percent of defoaming agent (based on total weight of CIP composition) equals m×+b (i.e., stability equation) where m is greater than about −131 and less than about −55, x is the weight % of defoaming agent and b is about 60.

The biocides which may be used in this invention include saturated fatty acids like caprylic (octanoic) acid, pelargonic (nonanoic) acid capric (decanoic) acid undercyclic (undecanoic) acid, lauric (dodecanoic) acid and mixtures thereof. Typically, the amount of biocide employed in the CIP composition of the present invention is from about 0.5 to about 5.0%, and preferably, from about 0.6 to about 4.0%, and most preferably, from about 0.7 to about 2.5% by weight, including all ranges subsumed therein. In a most preferred embodiment, a mixture of caprylic acid and capric acid is employed at a ratio of about 1:2 to about 2:1.

The CIP composition is pumped, via a pump and feed line, to the processing equipment targeted for cleaning, disinfecting or both. To the extent possible, the CIP composition is pumped through all internal portions of the equipment until it is finally discharged for recycling or waste. Moreover, the CIP composition of this invention may be pumped or sprayed on to the external surface of the equipment targeted for cleaning or disinfecting. The pumping is achieved via any art recognized pump. Such pumps may generally be classified as peristaltic, diaphragm or positive displacement pumps. The pumps are typically manufactured by suppliers like Watson-Marlow, Inc. and Tri-Clover, Inc. The spraying devices which may be used, for example, to spray the external portion of the processing equipment are typically distributed through establishments like System Cleaners A/S. The pumps and spraying devices which may be used in this invention may also be purchased from sanitary and hygiene specialists like DiverseyLever. Moreover, it is within the scope of this invention to make and store the CIP composition of this invention and use the composition as needed. It is also within the scope of this invention to make the CIP solution and to then feed the CIP solution directly to the pump responsible for delivering the composition. Still further, a combination of stored and newly made CIP composition may be fed to the pump responsible for delivering the composition.

As to the conduit that may be employed in this invention, such conduit is limited only to the extent that it is capable of transporting the CIP composition of this invention. The conduit is often a polymeric conduit or metal conduit, with stainless steel being especially preferred. Also, such conduit has an inside diameter ranging from about 0.25 cm to about 20 cm, but preferably, is from about 2.5 cm to about 10 cm.

The rate at which the CIP composition is delivered to the processing equipment is limited only to the extent that the rate does not prevent the CIP composition from cleaning and/or disinfecting the processing equipment targeted. Typically, however, the rate at which the CIP composition is delivered to the processing equipment is one which is selected or derived from maintaining a minimum linear velocity from about 1.5 to about 2.5 meters/second.

When the CIP composition is supplied to the processing equipment, one composition may be supplied having a single pH. It is also within the scope of this invention, however, to supply a CIP composition of a first pH followed by a CIP composition having a second pH. The alternating of CIP compositions having different pH values is often preferred when conditions of maximum cleaning and maximum disinfecting are desired.

The supplying of the CIP composition of this invention to processing equipment targeted for cleaning and/or disinfecting may be done in a manner such that the composition is fed into a single feed line of the processing equipment. In a preferred embodiment, the composition is fed into a feed line of each component of the processing equipment. A superior method for feeding solutions through a multitude of feeding lines in processing equipment may be found in Ser. No. 09/447,646 (Votteler et al.), commonly assigned to DiverseyLever, the disclosure of which is incorporated herein by reference.

It should be noted herein that the CIP composition of this invention comprises defoaming agent and cleaning agent. It is, however, within the scope of this invention for the composition to consist essentially of defoaming agent, cleaning agent and water. It is further within the scope of this invention for the composition to consist of defoaming agent, cleaning agent, hydrotrope, biocide and water. Moreover, when the CIP composition of this invention is pumped and/or sprayed, the CIP composition may be subjected to pressure and heat. Pressure and heat (e.g., temperature of the CIP composition) may vary and are only limited to the extent that the CIP composition may be used to clean and/or disinfect the processing equipment of concern.

The examples which follows below are provided to further illustrate and facilitate an understanding of the present invention. Therefore, the example is not meant to be limiting and modifications which fall within the scope and spirit of the claims are intended to be within the scope and spirit of the present invention.

### EXAMPLE 1

Two CIP compositions were made by mixing, under conditions of moderate sheer, the following components:

| | Weight % |
|---|---|
| Deionized water | 35.25 |
| Phosphoric Acid (75%) | 35.00 |
| Toluene Sulfonic Acid | 8.00 |
| Octenyl Succinic Acid | 1.60 |
| Capric and caprylic acid (1:1) | 17.40 |
| Triton H-66 | 2.00 |
| Plurafac LF 403 | 0.75 |

One CIP composition was maintained at 0° C. for 90 days and one CIP composition was maintained at 50° C. for 90 days. Both compositions did not display phase separation or precipitation after the 90 days.

### EXAMPLE 2

A foam testing rig having a vertical jacketed column, 75 cm in height and 6 cm in diameter, was assembled. At the top of the column, a glass tubing, having an inside diameter of 6 mm, was inserted as an inlet for CIP composition. The bottom of the column was stoppered with a No. 13 rubber stopper with two (2) 1 cm stainless steel outlets fitted with rubber tubing for CIP composition to return to a holding vessel. CIP compositions, similar to the ones made in Example 1, were circulated (after being diluted with 99% by weight water) through the holding vessel and through the column using a March centrifugal pump (Model No. AC-2CD-MD). Resulting falling solution created turbulence in the bottom of the column to thereby generate foam. Testing conditions were 5° C., and maintained with a temperature bath. The CIP compositions were circulated for about 45 seconds each. To determine total foam (Fₜ) produced, the height observed for pure deionized water (Fᵢ), which was circulated through the rig, was subtracted from the final foam height (F_{f}), with all heights being measured with a ruler attached to the column. After the analysis of the compositions of this invention, using the formula Fₜ=F_{f}−F_{I}, it was concluded the total foam height for such compositions was less than about 15.0 cm.

### EXAMPLES 3-5

Three CIP compositions were made by mixing, under moderate sheer, the components as outlined in the Table below. The foam height was determined for the compositions of Examples 3 to 5 at 5° C. according to the method previously described in Example 2.

| | Example 3 | Example 4 | Example 5 |
|---|---|---|---|
| Water -DI | 36.00% | 35.00% | 35.25% |
| Phosphoric Acid (75%) | 35.00% | 35.00% | 35.00% |
| Toluene Sulfonic Acid | 15.40% | 15.40% | 17.40% |
| Octenyl Succinic Acid | 8.00% | 8.00% | 8.00% |
| Caprylic and capric acid mixture | 1.60% | 1.60% | 1.60% |
| (1:1) | | | |
| Triton H-66 | 4.00% | 4.00% | 2.00% |
| Plurafac LF 403 | 0.00% | 1.00% | 0.75% |
| Foam Height @ 5 degrees C. | 18 | 2.5 | 5.5 |

The results set forth in Examples 1 and 5 show that the CIP compositions of the present invention unexpectedly remain stable and generate substantially no foam. Example 3 is a stable high foaming composition and Example 4 is low foaming unstable composition. Particularly, the composition of Example 4 has defoaming agent but does not satisfy the stability equation described herein.

We claim:

1. A cleaning-in-place composition comprising
(a) a defoaming agent; and
(b) a cleaning agent
wherein the CIP composition comprises a total foam height of less than about 15 cm at about 5° C.

2. The cleaning-in-place composition according to claim 1 wherein the cleaning-in-place composition comprises from about 0.2 to about 30.0% by weight defoaming agent.

3. The cleaning-in-place composition according to claim 1 wherein the defoaming agent is an alcohol alkoxylate.

4. The cleaning-in-place composition according to claim 1 wherein the cleaning-in-place composition comprises from about 0.3% to about 40.0% by weight cleaning agent.

5. The cleaning-in-place composition according to claim 1 wherein the cleaning agent has the formula: 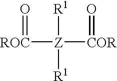
wherein Z is a C₂-C₈ saturated or unsaturated hydrocarbon, each R is independently a C₁₋₄ alkyl or H and each R¹ is independently a C₃ to C₁₈ alkyl group, a C₃ to C₁₈ hydrocarbon having at least one Sp² bond or Sp bond, —OR, or H with the proviso that at least one R¹ is not an —OR or an H.

6. A method for cleaning food processing equipment comprising the steps of:
(a) contacting an internal portion of food processing equipment with a CIP composition; and
(b) removing the CIP composition from the food processing equipment
wherein the CIP composition comprises a first hydrotrope, H¹, a second hydrotrope, H², and a defoaming agent, and the weight percent of H¹-H²/weight percent of defoaming agent equals mx+b where m is greater than about −131 and less than about −55, x is the weight percent of defoaming agent and b is about 60.

7. A method for cleaning food processing equipment according to claim 6 wherein the food processing equipment is brewery, dairy or carbonated beverage processing equipment.

8. A method for cleaning food processing equipment according to claim 6 wherein the cleaning agent has the formula: 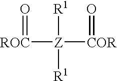
wherein Z is a C₂-C₈ saturated or unsaturated hydrocarbon, each R is independently a C₁₋₄ alkyl or H and each R¹ is independently a C₃ to C₁₈ alkyl group, a C₃ to C₁₈ hydrocarbon having at least one Sp² bond or Sp bond, —OR, or H with the proviso that at least one R¹ is not an —OR or an H.

9. A method for cleaning food processing equipment according to claim 6 wherein the method does not comprise a carbon dioxide purging step.

10. A method for cleaning food processing equipment according to claim 6 wherein the CIP composition comprises a mixture of caprylic and capric acid.
